(19) United States
(12) Patent Application Publication
(10) Pub. No.: US 2007/0262278 A1
(43) Pub. Date: Nov. 15, 2007

(54) Controlling Fluid Supply Valves

(75) Inventor: Nigel Peter Fox, Rugeley (GB)

Correspondence Address: THE OLLILA LAW GROUP LLC, 2060 BROADWAY, SUITE 300, BOULDER, CO, 80302, US

(73) Assignee: Norgren Limited, Staffordshire (GB)

(21) Appl. No.: 11/578,176

(22) PCT Filed: Apr. 11, 2005
(86) PCT No.: PCT/GB05/01395

§ 371 Date: Oct. 11, 2006

(30) Foreign Application Priority Data
Apr. 17, 2004 (GB) 0408606.2

(51) Int. Cl. F16K 31/524; F16K 1/14

(52) U.S. Cl. 251/62; 251/129.09; 251/129.14; 251/251; 251/264

(57) ABSTRACT

The invention relates to controlling the supply of fluid to a series of valves (1), in particular to the supply of air to a series of cuffs applying pressure to a wound. It is desirable to operate the series of valves by a single, small actuator (5) that does not require much power. A linear actuator is described comprising a solenoid operated plunger (15) having an external helical screw thread which co-operates with a drive ring (23). The drive ring (23) co-operates with cam means (8) which operate spring-loaded ball valves (30). A drive transmission (7) between the drive ring (23) and the cam means (8) allows movement of the cam means for one direction of movement of the linear actuator but not the other. A projection (25) on the cam means operate a first valve (1) until a second actuation closes the first valve and opens a second valve.

This invention relates to an actuation means for sequential control of a plurality of fluid supply valves.

Sequential control of fluid supply valves may be required in a number of situations. One is where compressed air or vacuum is supplied to a number of inflatable cuffs, typically four, providing varying pressure on a wound. Only one cuff changes state at any one time, and there is normally a predetermined sequence of inflation and deflation of the cuffs. Each cuff is supplied from a manifold, connected to compressed air or vacuum, under the control of its own fluid supply valve, which remains open until the state of the cuff is to be changed. In this situation, it is advantageous to provide operation of the valves in a simple and inexpensive way, without requiring too much power, and with the actuation means being as small as possible. Given these constraints, it is not feasible to provide an individual actuator for each valve, as this will make the actuation means too large, and relatively complex to control.

According to a first aspect of the present invention, an actuation means for sequential control of a plurality of fluid supply valves for controlling fluid flow between a fluid supply and a port comprises a reciprocable linear actuator operative to control all the valves through a rotary drive means, a transmission means and a cam means acting on the valves, the cam means being rotated by the drive means which translates movement of the linear actuator into rotary movement, and the transmission means being arranged between the drive means and the cam means such that the cam means is rotated by the drive means for one direction of movement of the linear actuator, but is not rotated for the other direction of movement of the linear actuator.

Thus, actuation of the linear actuator in one direction rotates the cam means to operate a first valve, which then remains operated when the linear actuator moves in the other direction to return to its original position. Another actuation rotates the cam means to return the first valve to its original position and to operate another valve, and so on. A single actuator can therefore operate all the valves, so that the actuation means can be kept small. The control of the actuator is simple, as any valve can be operated by a given number of actuations of the linear actuator. Further, because the valves remain operated when the actuator returns, no power is required to keep the valves open.

Preferably, the linear actuator comprises a solenoid acting on a non-rotatable member, against the action of a return spring. This keeps the power requirement to a minimum, as a pulse of current is all that is required to actuate the solenoid, which is then returned to its original position by the spring. Alternatively, the linear actuator may comprise a fluid-pressure operated piston acting on a non-rotatable member.

In either case the non-rotatable member has a helical engagement with the drive means, which is free to rotate. The helical engagement is preferably a screw thread. The drive means conveniently comprises a drive ring mounted externally on the non-rotatable member.

The transmission means may comprise a frictional engagement between the drive means and the cam means, which transmits rotary movement in one direction but not the other. Alternatively, the transmission means may comprise a toothed engagement such as ratchet teeth, which transmits rotary movement in one direction but allows the teeth to ride over each other in the other direction. Conveniently, movement is transmitted on the actuation stroke of the linear actuator rather than the return stroke.

The cam means may be a cylindrical member having an actuating cam for operating each valve. It may also have a neutral position, in which none of the valves are actuated. The actuating cams preferably comprise radial projections spaced round the cylindrical member.

Each fluid supply valve preferably comprises a spring-loaded ball valve, which is normally closed to prevent fluid flow to or from the port, and which is opened by movement of a pin operated by the cam.

According to a second aspect of the invention, we provide a series of inflatable cuffs for providing pressure on a wound dressing, a supply of fluid, valve means controlling inflation of the cuffs and an actuation means in accordance with the first aspect of the invention.

According to a third aspect of the invention, we provide a valve assembly for controlling fluid flow between a fluid supply and a plurality of ports the assembly comprising a fluid supply valve for each port and an actuation means in accordance with the first aspect of the invention for sequential control of the valves to control fluid flow between the fluid supply and each port.

An embodiment of the actuation means is illustrated in the accompanying drawings, in which:

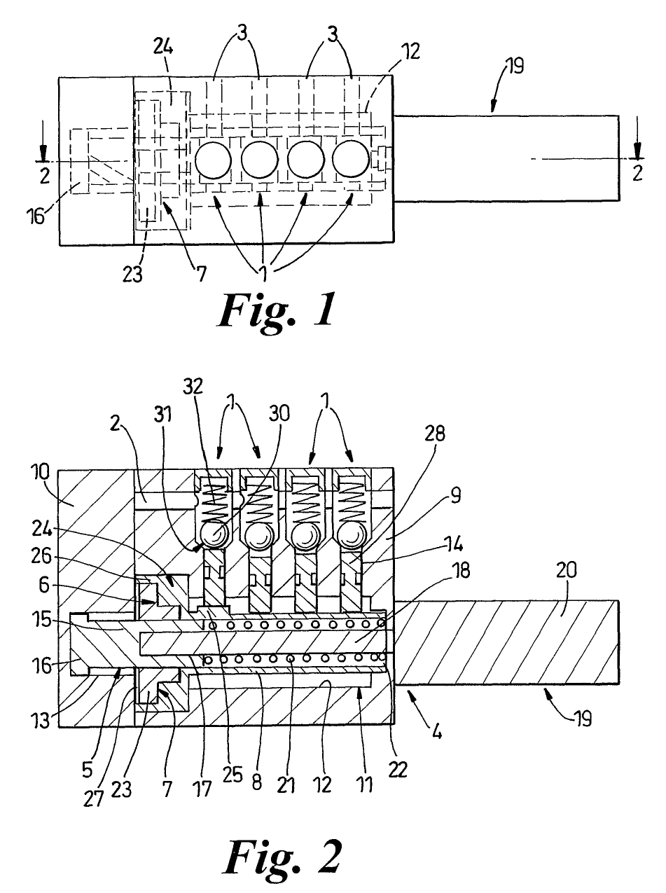

FIG. 1 is a plan view of an actuation means; and

FIG. 2 is a longitudinal section along the line 2-2 of FIG. 1.

The figures show a device for sequential control of a plurality of fluid supply valves 1. Each valve 1 controls the supply of compressed air or vacuum from a manifold 2 to a respective port 3. Each port 3 is connected to an inflatable cuff (not shown) providing pressure on a wound dressing. The cuffs are inflated or deflated sequentially, so that the state of no more than one cuff is changing at any given time. The device has actuation means 4 controlling operation of the valves 1, comprising a linear actuator 5, rotary drive means 6, drive transmission means 7 and cam means 8 which operates the valves 1.

The device comprises a housing body 9 closed by an end cap 10. The actuation means 4 is accommodated in a longitudinal bore 11, comprising a stepped main bore 12 in the housing body 9 and a blind bore 13 in the end cap 10. The housing body 9 also has a set of stepped bores 14, perpendicular to and opening into the main bore 12. Each bore 14 houses a valve 1, to be described in more detail later.

The linear actuator 5 of the actuator means 4 comprises a solenoid-operated plunger 15. The plunger 15 is cylindrical, but has a square end 16 received in the bore 13 in the end cap 10, so that it is non-rotatable. The plunger 15 has a blind bore 17 opening away from the end cap 10, in which is fixed the armature 18 of the solenoid 19. The solenoid coil 20 is provided outside the housing body 9. The plunger 15 is biased towards the end cap 10 by a spring 21 acting between the plunger and a shoulder 22 at the opposite end of the housing body 9. Externally, the cylindrical part of the plunger 15 has a helical screw-thread formation, which co-operates with a complementary internal screw-thread on the drive means 6.

The drive means 6 comprises a stepped ring 23 accommodated in a larger diameter portion of the bore 12. Linear movement of the plunger 15 in either direction rotates the drive ring 23 correspondingly, by a given angular amount, determined by the amount of the linear movement provided, and the helix angle of the screw-thread formation.

The drive ring 23 co-operates with the cam means 8 for operating the valves 1. The cam means 8 comprises a stepped cylindrical barrel 24 located round the spring 21. The barrel 24 has a radial cam projection 25 for operating each valve 1. Only one projection 25 is shown, as the others are spaced round the barrel 24 at appropriate axial locations to operate the valves.

The barrel 24 has an enlarged end 26 co-operating with the drive ring 23 through the drive transmission means 7, which is not shown in detail. The drive transmission means 7 comprises a toothed arrangement provided on complementary radial surfaces of the drive ring 23 and the end 26, and arranged so that rotary drive is transmitted from the drive ring 23 to the cam barrel 24 in one direction of rotation, but not the other. The drive transmission means therefore operates like a one-way clutch, and may be a ratchet-type toothed arrangement, with the teeth engaging to provide drive for one direction of rotation, but sliding over each other in the other direction of rotation. A clearance 27 is provided between the drive ring 23 and the end cap 10 to allow the teeth to separate. The drive ring 23 therefore has a limited amount of linear movement as well as rotary movement.

Thus, each actuation of the linear actuator 5 rotates the cam barrel 24 by the predetermined amount. The cam projections 25 will be arranged so that the cam barrel 24 has four positions in which only one valve 1 is operated, and a neutral position in which none of the valves 1 is operated. The angular rotation of the cam barrel 24 for each actuation is therefore 72°.

Each cam projection 25 acts on a valve actuation pin 28 working in a respective bore 14, to operate the corresponding valve 1.

Each valve 1 comprises a ball valve member 30 co-operating with a seat 31 formed at an inclined part of the bore 14. A spring 32 acts on the ball valve member 30 to bias it closed. The valve is opened by the actuation pin 28 lifting the ball 30 off the seat 31. When a valve 1 is open it allows fluid flow between the manifold 2 and the port 3. The manifold 2 may be connected, through a control valve (not shown), to a source of compressed air, a vacuum source, or to atmosphere. This allows inflation or deflation of the cuff controlled by the valve 1.

Thus, for operation, we assume that the cam barrel is in its neutral position, with no valves open. The manifold 2 is connected appropriately to the source of compressed air, vacuum or atmosphere. Current is supplied to the solenoid coil 20 as a short pulse. Operation of the solenoid pulls the armature 18 and the plunger 15 outwardly, which in turn pulls the drive ring 23 into engagement with the cam barrel 24. Movement of the plunger 15 also rotates the drive ring 23 and the cam barrel 24 by the given angular amount, as the drive is transmitted to the cam barrel 24 in this direction of movement. Rotation of the cam barrel 24 brings a cam projection 25 into engagement with an actuator pin 28 to open a valve 1 to allow fluid flow to or from the cuff via the port 3.

When the current ceases, the spring 21 returns the plunger 15 and the drive ring 23 to their original position. The clearance 27 ensures that the transmission means 7 disengages, so that the cam barrel 24 does not move. The actuated valve 1 therefore remains open until the next actuation of the solenoid, when that valve will close and another will open (unless the neutral position is required). The device will therefore operate to provide the required pressure at the ports 3, and is very simple in construction and operation, as it is only necessary to provide short pulses of current to the solenoid. Actuation of any given valve 1 can be ensured by an appropriate number of current pulses to the solenoid.

It will be appreciated that the linear actuator 5 could be operated by a piston rather than the solenoid. Similarly, it will be appreciated that the drive transmission means 7 could be modified, and may simply rely on friction rather than a toothed engagement. For example, a friction drive may be in the form of self-releasing tapers on the complementary radial surfaces of the ring 23 and end 26.

It would also be possible for the rotation of the cam barrel 24 to occur on the return stroke of the linear actuator 5 rather than the actuation stroke.

The device can readily be modified to accommodate more or fewer valves. The valves may also be of a different type.

Furthermore, it will be appreciated that the actuator/solenoid may be located either wholly or partially inside or parallel to the cam barrel to reduce the overall length of the actuator means if desired.

1. An actuation means (4) for sequential control of a plurality of fluid supply valves (1) for controlling fluid flow between a fluid supply (2) and a port (3) characterised in that the actuation means comprises:
a reciprocable linear actuator (5) operative to control the plurality of fluid supply valves (1) through a rotary drive means (6), a transmission means (7) and a cam means (8) acting on the plurality of fluid supply valves (1), the cam means (8) being rotated by the drive means (6) which translates movement of the linear actuator (5) into rotary movement and the transmission means (7) being arranged between the drive means (6) and the cam means (8) such that the cam means (8) is rotated by the drive means (6) for one direction of movement of the linear actuator (5), but is not rotated for the other direction of movement of the linear actuator.

2. The actuation means according to claim 1, characterised in that the reciprocable linear actuator comprises a solenoid (19) acting on a non-rotatable member (15) against the action of a return spring (21).

3. The actuation means according to claim 1, characterised in that the reciprocable linear actuator (5) comprises a fluid-pressure operated piston acting on a non-rotatable member.

4. The actuation means according to claim 3, characterised in that the non-rotatable member (15) has a helical engagement with the drive means (6) where the helical engagement is a screw thread.

5. (canceled)

6. The actuation means according to claim 3, characterised in that the rotary drive means (6) comprises a drive ring (23) mounted externally on the non-rotatable member (15).

7. The actuation means according to claim 1, characterised in that the transmission means (7) comprises a factional engagement between the drive means (6) and the cam means (8) which transmits rotary movement in one direction but not the other.

8. The actuation means according to claim 1, characterised in that the transmission means (7) comprises a toothed engagement which transmits rotary movement in one direction but allows the teeth to ride over each other in the other direction.

9. The actuation means according to claim 8, characterised in that the transmission means are ratchet teeth.

10. The actuation means according to claim 1, characterised in that movement of the linear actuator is transmitted on an actuation stroke of the linear actuator.

11. The actuation means according to claim 1, characterised in that the cam means (8) is a cylindrical member (24) having an actuating cam (25) for operating each of the plurality of fluid supply valves (1).

12. The actuation means according to claim 11, characterised in that the cam means (8) has a neutral position in which none of the plurality of fluid supply valves (1) are operated.

13. The actuation means according to claim 11, characterised in that the actuating cams comprise radial projections (25) spaced around the cylindrical member (24).

14. The actuation means according to claim 1, characterised in that each of the plurality of fluid supply valves (1) comprises a spring-loaded ball valve.

15. The actuation means according to claim 14 characterised in that each spring-loaded ball valve is normally closed to prevent fluid flow to or from the port.

16. The actuation means according to claim 15, characterised in that each spring-loaded ball valve is opened by movement of a pin (28) operated by the cam means (8).

17. The activation means of claim 1, further comprising:
a series of inflatable cuffs for providing pressure on a wound dressing, a supply of fluid, valve means controlling inflation of the cuffs, where the activation means is used for controlling the valve means to control fluid flow between the fluid supply and the cuffs.

18. The activation means of claim 1, further comprising:
a valve assembly device for controlling fluid flow between a fluid supply and a plurality of ports the assembly comprising a fluid supply valve for each port where the activation means is used for sequential control of the plurality of fluid supply valves to control fluid flow between the fluid supply and each of the plurality of ports.
